(19) United States
(12) Patent Application Publication
(10) Pub. No.: US 2017/0099622 A1
(43) Pub. Date: Apr. 6, 2017

(54) RESTORATION OF PACKET DATA CONNECTIVITY TO A TELEMATICS UNIT FOLLOWING NETWORK FAILURE

(71) Applicants: General Motors LLC, Detroit, MI (US); GM Global Technology Operations LLC, Detroit, MI (US)

(72) Inventors: Scott T. DROSTE, West Bloomfield, MI (US); David GEORGE, Farmington Hills, MI (US); Dipankar PAL, Sylvania, OH (US)

(21) Appl. No.: 14/876,001

(22) Filed: Oct. 6, 2015

(51) Int. Cl. H04W 36/12; H04W 40/24; H04W 24/08

(52) U.S. Cl. CPC H04W 36/12; H04W 24/08; H04W 40/248

(57) ABSTRACT

A system and method are provided for maintaining packet-switched connectivity in a cellular communications system. The method includes monitoring at least one connectivity parameter, detecting a gateway failure in a packet-switched communication system based on the at least one connectivity parameter, and performing a remedial action to restore packet-switched connectivity in response to detecting the gateway failure.

### TECHNICAL FIELD

The present invention relates to packet-switched communication, and more particularly, to identifying and restoring a connectivity failure to a packet data network (PDN) gateway.

### BACKGROUND

As wireless technologies advance, telematics services have become more reliant on packet-switched communication services and protocols for end-to-end connectivity between telematics units and various service providers. These packet-switched connections typically employ Internet protocol (IP) connectivity, which is the basic communication language or protocol of the Internet. As the dependency on packet-switched services increases, so does the need to establish and maintain these packet-switched connections.

Packet-switched networks generally include a packet data network (PDN) gateway, whose primary function within a wireless cellular core network is to assign and maintain IP address assignments and context management for subscribed and connected user equipment, such as a vehicle telematics unit. If the PDN gateway serving a telematics unit sustains a failure (or is taken offline for maintenance activity) and then restored to operational capability, the PDN gateway may lose all IP address assignments prior to the failure event. The net effect is that telematics unit using the previously assigned IP address (i.e., address assigned prior to the failure event) will be unable to establish IP connectivity to any peer beyond the PDN gateway, and as a result, will be unable to perform packet routing functions. This failure scenario may impact all telematics units having established a context with the PDN gateway prior to the failure and may number in the thousands. Further, the loss of packet data connectivity may last for an indefinite period of time following the PDN gateway returning to operational capability.

### SUMMARY

According to an embodiment of the invention, there is provided a method for maintaining packet-switched connectivity in a cellular communications system. The method includes monitoring at least one connectivity parameter, detecting a gateway failure in a packet-switched communication system based on the at least one connectivity parameter, and performing a remedial action to restore packet-switched connectivity in response to detecting the gateway failure.

According to another aspect of the invention, there is provided a system for maintaining packet-switched connectivity in a cellular communications system. The system includes a vehicle control module configured to monitor at least one connectivity parameter, detect a gateway failure in a packet-switched communication system based on the at least one connectivity parameter, and perform a remedial action to restore packet-switched connectivity in response to detecting the gateway failure.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is another exemplary cellular communications system that is capable of utilizing the method disclosed herein; and

FIG. 3 is a flow chart depicting a method identifying and restoring a connectivity failure to a PDN gateway according to an embodiment of the disclosed invention.

### DETAILED DESCRIPTION OF THE ILLUSTRATED EMBODIMENT(S)

The system and method described below pertain to maintaining packet-switched connectivity by detecting an IP-level connectivity failure, such as a packet data network (PDN) gateway failure, and executing actions to re-establish IP connectivity. The system employs an algorithm to detect a PDN gateway failure by monitoring a plurality of connectivity parameters, which include a failed domain name server (DNS) query, a failure to establish connectivity to a remote server, and/or an expired packet-switched connection timer. If any individual or combination of connectivity parameters is present, a flag is set to indicate a possible PDN gateway failure event. Thereafter, attempts are made to re-establish packet-switched connectivity as set forth below.

### Communications System—

The following detailed description is merely exemplary in nature and is not intended to limit the application and uses. Furthermore, there is no intention to be bound by any expressed or implied theory presented in the preceding technical field, background, brief summary, or the following detailed description.

Referring to the Figures, wherein like numerals indicate like parts throughout the several views, there is shown an operating environment that comprises a mobile vehicle communications system 10 that can be used to implement the method disclosed herein. While the approach and methodology described below relate to vehicle communications, one of ordinary skill in the art appreciates that an automotive application is merely exemplary, and that the concepts disclosed herein may also be applied to any other suitable communications system, but more specifically, non-vehicle applications. The term vehicle as described herein is also to be construed broadly to include not only a passenger car, but any other vehicle including, but not limited to, motorcycles, trucks, sports utility vehicles (SUVs), recreational vehicles (RVs), marine vessels, and aircraft.

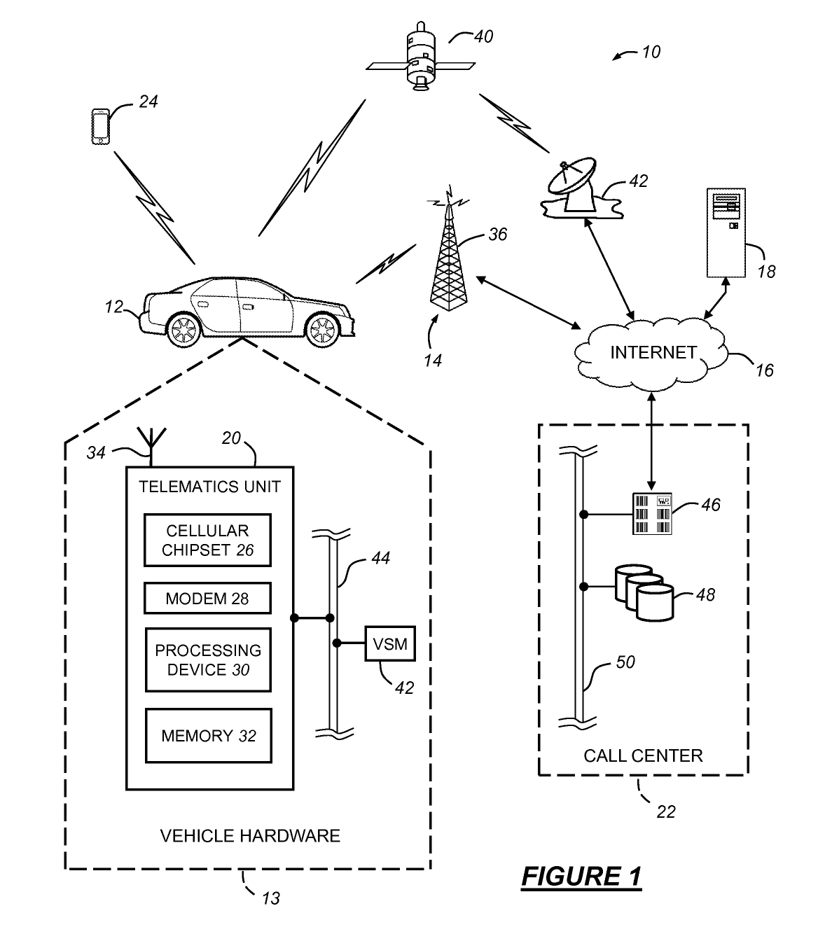

With reference to FIG. 1, there is shown an operating environment that comprises a vehicle communications system 10 that can be used to implement the method disclosed herein. Communications system 10 generally includes a vehicle 12, one or more wireless carrier systems 14, Internet 16, computer 18, and call center 22. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

As shown in FIG. 1, vehicle 12 includes vehicle hardware 13 having a telematics unit 20, which can be an OEM-installed (embedded) or an aftermarket device that is installed in the vehicle and that enables wireless voice and/or data communication over wireless carrier system 14 and via wireless networking. This enables the vehicle 12 to communicate with the vehicle call center 22, other telematics-enabled vehicles, or some other entity or device, such as a consumer device 24 or other remote Internet server. In one embodiment the telematics unit 20 uses radio transmissions to establish a communications channel (a voice channel and/or a data channel) with wireless carrier system 14 so that voice and/or data transmissions can be sent and received over the channel. By providing both voice and data communication, telematics unit 20 enables the vehicle 12 to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

According to one embodiment, telematics unit 20 utilizes cellular communication according to either GSM, CDMA, or LTE standards and thus includes a cellular chipset 26 for voice communications like hands-free calling, a wireless modem 28 for data transmission, an electronic processing device 30, one or more digital memory devices 32 including volatile and non-volatile memory, and a dual antenna 34. It should be appreciated that the cellular chipset 26 and modem 28 can either be implemented through software that is stored in the telematics unit 20 and is executed by processor 30, or can be separate hardware components located external to telematics unit 20. The cellular chipset 26 and modem 28 can operate using any number of different standards or protocols such as LTE, EVDO, CDMA, GPRS, and EDGE. In one embodiment, the cellular chipset and/or modem is a multi-radio access technology (multiRAT) chipset/modem configured to support the wireless networking employed by the disclosed method. Wireless networking between the vehicle and other networked devices (including consumer device 24) can also be carried out using telematics unit 20. For this purpose, telematics unit 20 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit 20 can be configured with a static IP address or can be set up to automatically receive an assigned IP address from another device on the network.

Processor 30 can be any type of device capable of processing electronic instructions including microprocessors, microcontrollers, host processors, controllers, vehicle communication processors, field programmable gate arrays (FPGA), and application specific integrated circuits (ASICs). Processor 30 can be a dedicated processor used only for telematics unit 20 or can be shared with other vehicle systems. Processor 30 executes various types of digitally-stored instructions, such as software or firmware programs stored in memory 32, which enable the telematics unit 20 to provide a wide variety of services. For instance, processor 30 can execute programs or process data to carry out at least a part of the method discussed herein.

Telematics unit 20 can be used to provide a diverse range of vehicle services that involve wireless communication to and/or from the vehicle. Such services include: turn-by-turn directions and other navigation-related services that are provided in conjunction with a GPS-based vehicle navigation module; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module and is stored for current or later playback. The above-listed services are by no means an exhaustive list of all of the capabilities of telematics unit 20, but are simply an enumeration of some of the services that the telematics unit is capable of offering. Furthermore, it should be understood that at least some of the aforementioned modules could be implemented in the form of software instructions saved internal or external to telematics unit 20, they could be hardware components located internal or external to telematics unit 20, or they could be integrated and/or shared with each other or with other systems located throughout the vehicle, to cite but a few possibilities. In the event that the modules are implemented as vehicle system modules 42 located external to telematics unit 20, they could utilize vehicle bus 44 to exchange data and commands with the telematics unit 20.

Wireless carrier network 14 is preferably a cellular telephone system that includes a plurality of cell towers 36 (only one shown) as well as any other networking components required to connect wireless carrier system 14 with Internet 16. Each cell tower 36 includes sending and receiving antennas and a base station. As will be appreciated by those skilled in the art, various cell tower/base station arrangements are possible and could be used with wireless system 14. For instance, the base station and cell tower could be co-located at the same site or they could be remotely located from one another, each base station could be responsible for a single cell tower or a single base station could service various cell towers, to name but a few of the possible arrangements. Cellular system 14 can implement any suitable communications technology, including for example, analog technologies such as AMPS, or the newer digital technologies such as CDMA (e.g., CDMA2000), UMTS, EDGE, GSM/GPRS, etc. Wireless carrier network 14 also includes access networks such as, for example, GERAN, UTRAN, and E-UTRAN.

Apart from using wireless carrier network 14, a different wireless carrier system in the form of satellite communication can be used to provide uni-directional or bi-directional communication with the vehicle. This can be done using one or more communication satellites 40 and an uplink transmitting station 42. Uni-directional communication can be, for example, satellite radio services, wherein programming content (news, music, etc.) is received by transmitting station 42, packaged for upload, and then sent to the satellite 40, which broadcasts the programming to subscribers. Bi-directional communication can be, for example, satellite telephony services using satellite 40 to relay telephone communications between the vehicle 12 and station 42. If used, this satellite telephony can be utilized either in addition to or in lieu of wireless carrier network 14. Additionally, the variety of communications alternatives can reside in licensed or unlicensed bands as well as free of charge or charged systems.

Internet 16 is a global infrastructure of interconnected computer networks to link billions of devices worldwide. Internet 16 is an international network of networks that consists of millions of private, public, academic, business, and government packet-switched networks linked by a broad array of electronic, wireless, and optical networking technologies. These computer networks are accessible through the vehicle 12 via telematics unit 20 and wireless carrier system 14 and include, but are not limited to, all servers that host websites, proprietary servers, and DNS servers.

Computer 18 can be one of a number of computers accessible via a private or public network such as the Internet. Each such computer 18 can be used for one or more purposes, such as an Internet server accessible by the vehicle via telematics unit 20 and wireless carrier system 14. Other such accessible computers 18 can be, for example: a service center computer where diagnostic information and other vehicle data can be uploaded from the vehicle via the telematics unit 20; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 22, or both. A computer 18 can also be used for providing Internet connectivity such as DNS services or as a network address server that uses DHCP or other suitable protocol to assign an IP address to the vehicle 12.

Call center 22 is designed to provide the vehicle hardware 13 with a number of different system back-end functions and, according to the exemplary embodiment shown here, generally includes one or more servers 46 and database(s) 48. These various call center components are preferably coupled to one another via a wired or wireless local area network 50. Data transmissions are passed via the modem to server 46 and/or database 48. Database 48 can store account information such as subscriber authentication information, vehicle identifiers, profile records, behavioral patterns, and other pertinent subscriber information. Data transmissions may also be conducted by wireless systems, such as 802.11x, GPRS, and the like.

The operating environment may further include one or more consumer devices 24. In one embodiment, the consumer device 24 may be an electronic device used to make mobile telephone calls across a wide geographic area where transmissions are facilitated by the wireless carrier system 14 (i.e., when the consumer device 24 is connected to the wireless carrier system 14 through the telematics unit 20). The consumer device 24 may include: hardware, software, and/or firmware enabling cellular telecommunications and communications via short-range wireless communication (e.g., Wi-Fi Direct and Bluetooth) as well as other mobile consumer device applications. Such device applications may include software applications, which may be preinstalled or installed by the user.

The hardware of the consumer device 24 may have electronics known to skilled artisans including a communication interface(s), an antenna, etc. In addition, modern consumer devices 24 may also support additional services and/or functionality such as short messaging service (SMS or texts), multimedia messaging service (MMS), email, internet access, as well as business and gaming applications. Non-limiting examples of the consumer device 24 include a mobile cellular telephone, a personal digital assistant (PDA), a Smart Phone, a tablet, a personal laptop computer having two-way communication capabilities, a netbook computer, or any suitable combinations thereof.

The communication between the computer 18, the consumer device 24, and the telematics unit 20 is generally governed by the Transmission Control Protocol/Internet Protocol (TCP/IP), which is the basic communication language or protocol of the Internet 16. TCP/IP is a two-layer program. The higher layer, TCP, manages the assembling of a message or file into smaller packets that are transmitted over the Internet 16 and received by a TCP layer that reassembles the packets into the original message. The lower layer, IP, handles the address part of each packet so that the packet gets to the right destination. Each gateway computer on the network checks this address to see where to forward the message. Even though some packets from the same message are routed differently than others, they'll be reassembled at the destination.

TCP/IP uses the client/server model of communication and is primarily point-to-point, meaning each communication is from one point (or host computer) in the network to another point or host computer. When set up with direct access to the Internet 16 a computing device includes a copy of the TCP/IP program, which provides end-to-end connectivity specifying how data should be packetized, addressed, transmitted, routed, and received at the destination. This functionality is organized into four abstraction layers that are used to sort all related protocols according to the scope of networking involved. From lowest to highest, the layers are the link layer, which contains communication technologies for a single network segment (link); the Internet layer, which connects hosts across independent networks; the transport layer handling host-to-host communication; and the application layer, which provides process-to-process application data exchange. As set forth above, TCP/IP provides for a singular end-to-end connection between hosts (e.g., a client and a server). While packets that are being transmitted using TCP/IP may take multiple routes to the destination through routers, there nonetheless remains only a single connection between the two hosts.

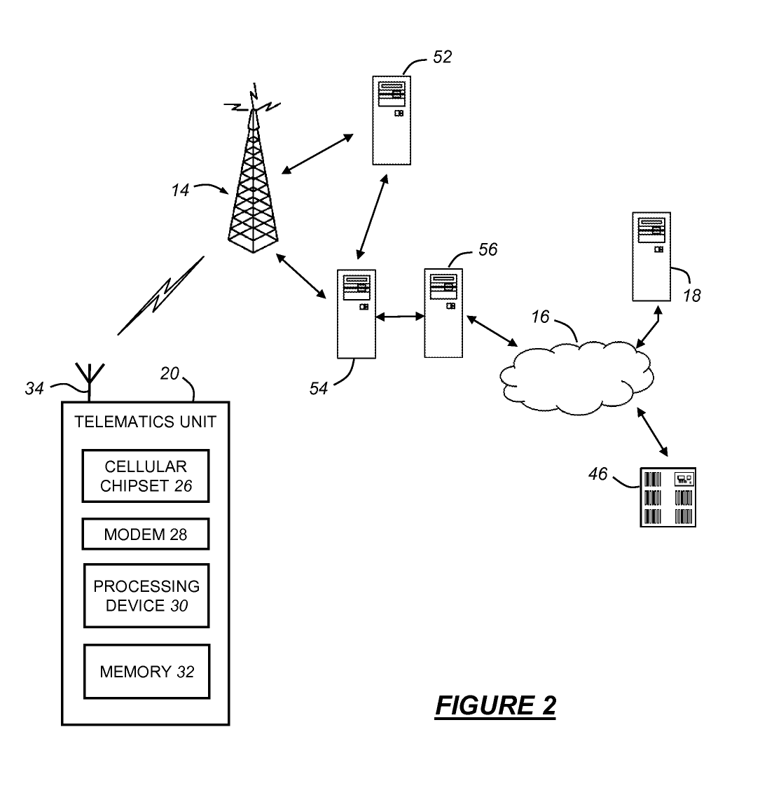

FIG. 2 illustrates an embodiment of the communications system shown in FIG. 1 that is capable of utilizing the method disclosed herein. One of ordinary skill in the art appreciates that the system in FIG. 2 is exemplary and that the method disclosed herein may be implemented using different architectures and standards. More specifically, one of ordinary skill in the art understands that while the disclosed method is presented below with respect to an LTE network, other wireless communication standards may also be used. In addition, one of ordinary skill in the art appreciates that the use of the telematics unit 20 is exemplary and that any suitable user equipment (e.g., consumer device 24, etc.) may be employed.

FIG. 2 illustrates an exemplary implementation of a communications system that employs an all-IP system architecture evolution (SAE), which is the core network architecture for the LTE wireless communication standard. LTE networks deliver all user traffic in IP packets and provide users with “always-on IP connectivity.” When user equipment such as telematics unit 20 joins an LTE network, a packet data network (PDN) address is assigned to the telematics unit 20 for its connection to the PDN, and a default bearer is established in the LTE network between the telematics unit 20 and a PDN gateway. This default bearer remains connected (i.e. the IP address assigned to the telematics unit 20 during the initial attach remains valid) until the telematics unit 20 is detached from the LTE network. A default bearer is established for each access point name (APN) a user has, and thus a unique IP address is assigned for each APN. An IP address can be an IPv4, IPv6 or IPv4/IPv6 type.

The primary component of the SAE architecture is the evolved packet core (EPC), which includes a mobility management entity (MME) 52, a serving gateway (SGW) 54, and a PDN gateway 56. The MME 52 is the main control-node and is involved in the bearer activation/deactivation process and is also responsible for choosing the SGW 54 for any user equipment at the initial attach and at the time of an intra-system handover involving core network (CN) node relocation. The MME also provides the control plane function for mobility between LTE and 2G/3G access networks.

The SGW 54 routes and forwards user data packets, while also acting as the mobility anchor for the user plane during inter-node handovers and as the anchor for mobility between LTE and other 3rd Generation Partnership Project (3GPP) technologies. The SGW 54 manages and stores telematics unit 20 information such as parameters of the IP bearer service and network internal routing information.

The PDN gateway 56 provides connectivity from the telematics unit 20 to external packet data networks by the point of entry and exit for traffic to and from the telematics unit 20. One of ordinary skill in the art appreciates that there may be more than one PDN gateway 56 in a particular network and that the telematics unit 20 may have simultaneous connectivity with more than one PDN gateway for accessing multiple packet data networks. When the telematics unit 20 initially attaches to a network, it requests a PDN connection. The PDN gateway then allocates an IP address (i.e. PDN address) to be used by the telematics unit 20 for the PDN, and forwards it to the telematics unit 20 while a default bearer connecting the two is being established.

The PDN gateway 56 allocates IP addresses in two ways: dynamic or static IP address allocation. In case of dynamic allocation, it automatically assigns an IP address every time the telematics unit 20 accesses the network. On the other hand, in case of static allocation, it assigns a designated IP address to the telematics unit 20 upon its subscription, and then allocates the designated IP address every time it accesses the network. With this IP address, the telematics unit 20 can use services provided through the PDN. However, if the PDN gateway 56 sustains a failure, or is otherwise taken offline, the PDN gateway 56 may lose all IP address assignments made to the telematics unit 20 and other user equipment.

### Method—

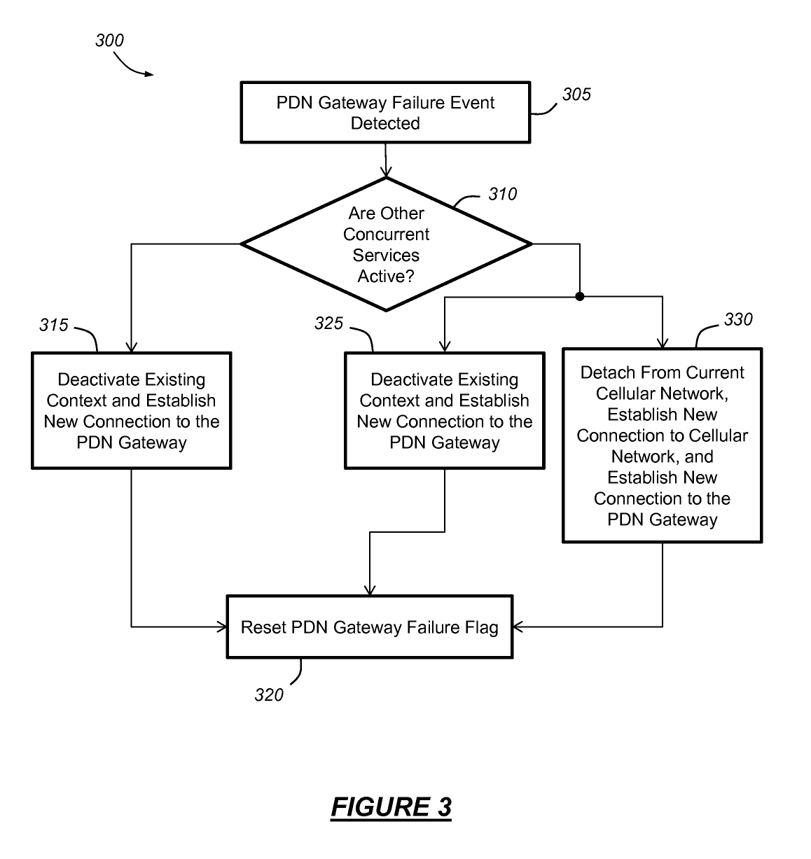

Turning now to FIG. 3, there is a method 300 for maintaining packet-switched connectivity by detecting an IP-level connectivity failure and executing actions to re-establish IP connectivity. The method described below is implemented using the telematics unit 20, however, one of ordinary skill in the art understands that the disclosed method may also be implemented in whole or in part by a processing device and/or control module external to the telematics unit 20.

The method 300 begins at step 305 with telematics unit 20 detecting a potential PDN gateway 56 event, which generally refers to a loss of connectivity associated with a PDN gateway 56. The loss of connectivity may be due to a failure of the PDN gateway 56 or because the PDN gateway 56 has, for various reasons, been taken offline. To detect a potential PDN gateway 56 event, the system monitors a plurality of connectivity parameters and sets a PDN gateway flag when at least one of the connectivity parameters is triggered. In one embodiment, the plurality of connectivity parameters includes a failed domain name server (DNS) query, a failure to establish connectivity to a remote server, and/or an expired packet-switched connection timer.

By way of background, devices that connect to the Internet use a numerical IP address to route a request from the device to a particular server that hosts a site on the Internet. The request from the device, however, is generally in a human-readable domain name format (e.g., www.xxx.com), which cannot be directly read by computers. To resolve this format discrepancy, a Domain Name System (DNS) protocol is used to translate a user-friendly domain name into an IP address—a process referred to as DNS name resolution. This process utilizes DNS servers, which manage massive databases that map domain names to IP addresses. In practice, when a device connects to an Internet Service Provider (ISP), or through a WiFi network, the modem or router that assigns the device's network address also provides configuration data including one or more DNS servers that the device uses to translate DNS names to IP addresses. In other words, in this case, the telematics unit 20 queries the assigned DNS servers to resolve the name. This query is transmitted through the wireless cellular system 14. However, given that a PDN gateway 56 failure will result in an inability to route IP packet traffic to and from the telematics unit 20, the DNS query will fail to produce a response from the targeted DNS server. Additionally, any further attempts at resolving the telematics server address through subsequent DNS queries will also fail. This failure to obtain a response to an initial and/or subsequent DNS query is an indicator of a possible PDN gateway event. Consequently, upon a failed DNS query a PDN gateway failure flag is set.

Another connectivity parameter relates to a failure to establish connectivity to a remote server 18, 46. In this case, the telematics unit 20 may possess the IP address of a target server a priori, thus eliminating the need to perform a DNS query to resolve the fully qualified domain name or uniform resource identifier to an IP address. The telematics unit 20 would then employ typical standardized Internet protocols such as, for example, the user datagram protocol (UDP), TCP, or other known data networking protocols to establish packet-switched connectivity with the server 18, 46. Similar to the DNS query, a PDN gateway 56 event will render the packet-switched data routing between the telematics unit 20 and any server nonfunctional. The resulting failure to obtain a response to an initial and/or subsequent protocol establishment process is an indicator of a possible PDN gateway event. Consequently, upon a failure to establish connectivity to a remote server 18, 46 a PDN gateway failure flag is set.

And finally, the telematics unit 20 may initiate a packet-switched connection timer as a means for detecting a possible PDN gateway event. In this case, the telematics unit 20 starts a timer when it commences establishing a packet-switched connection with a remote server. The timer has a predetermined threshold that is generally greater than a typical period of time to complete a successful packet-switched connection. A failure to establish packet-switched connectivity between the telematics unit 20 and the remote server prior to the expiration of the timer indicates a possible PDN gateway event. Consequently, upon expiration of the connection timer a PDN gateway failure flag is set.

Returning to FIG. 3, upon detection of a PDN gateway failure flag indicating a potential PDN gateway 56 event, the telematics unit 20 takes remedial action to restore packet-switched connectivity. In one embodiment, the remedial action includes: 1) reinitiating a PDN connection; or 2) reestablishing a cellular network connection. The type of remedial action to be taken depends on the existence of other ongoing concurrent services. For example, the process of reestablishing a cellular network connection includes detaching the telematics unit 20 from the current cellular network. Disconnecting from the cellular network will consequently terminate any other concurrent services such as, for example, a circuit-switched service (e.g., a voice call) or a packet data service that has connectivity through a PDN gateway other than the PDN gateway for which the PDN gateway failure flag was set. Therefore, at step 310 the telematics unit 20 first determines if other ongoing concurrent services are active. If any concurrent services are active, then at step 315 the telematics unit 20 reinitiates the connection to the PDN by deactivating the existing packet data protocol (PDP) context or EPS bearer context with the PDN gateway 56 and establishes a new PDP or EPS bearer context with the PDN gateway 56. In one embodiment, the initial connection between the telematics unit 20 to the PDN gateway 56 is deactivated by performing non-access stratum (NAS) signaling procedures per applicable wireless standards to release the established session management context. As known to one of ordinary skill in the art, the NAS is a set of protocols in the evolved packet system (EPS) (i.e., LTE+EPC) used to convey non-radio signaling between user equipment such as telematics unit 20 and the MME 52 for LTE/E-UTRAN access. By releasing the established session management context, the IP address previously assigned to the telematics unit 20 is released. NAS signaling procedures are again performed to establish a new session management context with the PDN gateway 56 through MME 52 and SGW 54. The PDN gateway 56 assigns a new IP address to the telematics unit 20 during the session management context, which will be used for all subsequent packet data connections. Upon establishing the new PDP context/EPS bearer context with the PDN gateway 56, at step 320 the PDN gateway failure flag is reset.

Returning to step 310, if no other ongoing concurrent services are active, the telematics unit 20 restores packet-switched connectivity using either type of remedial action as set forth above. In other words, if no concurrent services are active, packet-switched connectivity can be restored by either reinitiating the PDN connection at step 325 as described above, or by reestablishing at step 330 a cellular network connection. In one embodiment, detaching from the cellular network currently serving the telematics unit 20 is accomplished by performing NAS signaling procedures per applicable wireless standards to release the established session management context, thereby releasing the IP address previously assigned to the telematics unit 20. Network selection procedures as known in the art are then performed to either attach to a new cellular network, or to re-attach to the previous cellular network. In either case, NAS signaling procedures are again performed to establish a new session management context with the PDN gateway 56 through MME 52 and SGW 54. The PDN gateway 56 assigns a new IP address to the telematics unit 20 during the session management context, which will be used for all subsequent packet data connections. Upon establishing the new PDP context/EPS bearer context with the PDN gateway 56, at step 320 the PDN gateway failure flag is reset.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method for maintaining packet-switched connectivity in a cellular communications system, the method comprising the steps of:
monitoring at least one connectivity parameter;
detecting a gateway failure in a packet-switched communication system based on the at least one connectivity parameter; and
performing a remedial action to restore packet-switched connectivity in response to detecting the gateway failure.

2. The method of claim 1, wherein the at least one connectivity parameter includes one or more of the following: a DNS query, connectivity to a remote server, and a packet-switched connection timer.

3. The method of claim 1, wherein the gateway is a PDN gateway.

4. The method of claim 3, further comprising setting a PDN gateway failure flag upon a failed DNS query, a failure to establish connectivity to a remote server, and/or an expired packet-switched connection timer.

5. The method of claim 4, wherein detecting a PDN gateway failure includes detecting the PDN gateway failure flag.

6. The method of claim 1, further comprising determining whether concurrent services are active.

7. The method of claim 6, wherein concurrent services include a circuit-switched service and/or a packet data service.

8. The method of claim 6, wherein the gateway is a PDN gateway, and if concurrent services are active, the remedial action to restore packet-switched connectivity includes reinitiating a PDN connection.

9. The method of claim 8, wherein reinitiating the PDN connection includes:
deactivating an existing PDP context or EPS bearer context with the PDN gateway; and
establishing a new PDP or EPS bearer context with the PDN gateway.

10. The method of claim 6, wherein the gateway is a PDN gateway, and if concurrent services are not active, the remedial action to restore packet-switched connectivity includes reinitiating a PDN connection or reestablishing a cellular network connection.

11. The method of claim 10, wherein reestablishing a cellular network connection includes:
detaching from a current cellular network providing pack switched connectivity;
attaching to a new cellular network or a previously connected cellular network; and
establishing a new PDP or EPS bearer context with the PDN gateway.

12. The method of claim 10, wherein reinitiating the PDN connection includes:
deactivating an existing PDP context or EPS bearer context with the PDN gateway; and
establishing a new PDP or EPS bearer context with the PDN gateway.

13. A system for maintaining packet-switched connectivity in a cellular communications system, the system comprising:
a vehicle control module configured to:
monitor at least one connectivity parameter;
detect a gateway failure in a packet-switched communication system based on the at least one connectivity parameter; and
perform a remedial action to restore packet-switched connectivity in response to detecting the gateway failure.

14. The system of claim 13, wherein the vehicle control module is a vehicle telematics unit.

15. The system of claim 14, wherein the gateway is a PDN gateway.

16. The system of claim 15, wherein detecting a PDN gateway failure includes detecting the PDN gateway failure flag.

17. The system of claim 16, wherein the vehicle telematics unit is further configured to determine whether concurrent services are active, wherein concurrent services include a circuit-switched service and/or a packet data service.

18. The system of claim 17, wherein if concurrent services are active, the remedial action to restore packet-switched connectivity includes deactivating an existing PDP context or EPS bearer context with the PDN gateway, and establishing a new PDP or EPS bearer context with the PDN gateway.

19. The system of claim 17, wherein if concurrent services are not active, the remedial action to restore packet-switched connectivity includes either reinitiating a PDN connection, or reestablishing a cellular network connection.

20. The system of claim 19, wherein reinitiating a PDN connection includes deactivating an existing PDP context or EPS bearer context with the PDN gateway, and establishing a new PDP or EPS bearer context with the PDN gateway, and wherein reestablishing a cellular network connection includes detaching from a current cellular network providing pack switched connectivity, attaching to a new cellular network or a previously connected cellular network, and establishing a new PDP or EPS bearer context with the PDN gateway.
